(19) United States
(12) Patent Application Publication
(10) Pub. No.: US 2024/0289023 A1
(43) Pub. Date: Aug. 29, 2024

(54) STORAGE SYSTEM AND I/O REQUEST PROCESSING METHOD FOR STORAGE SYSTEM

(71) Applicant: Hitachi, Ltd., Tokyo (JP)

(72) Inventors: Kei NAKAHAMA, Tokyo (JP); Masakuni AGETSUMA, Tokyo (JP); Keisuke SUZUKI, Tokyo (JP); Hiroaki MIYATA, Tokyo (JP); Tappei KATSUNAGA, Tokyo (JP)

(21) Appl. No.: 18/240,374

(22) Filed: Aug. 31, 2023

(30) Foreign Application Priority Data
Feb. 28, 2023 (JP) 2023-029495

(51) Int. Cl. G06F 3/06

(52) U.S. Cl. CPC G06F 3/0613; G06F 3/0655; G06F 3/067

(57) ABSTRACT

Regarding cloud storage, a time-out of an I/O response to an I/O request from a host is deterred. A storage node 1 executes an I/O processing thread 101 for retaining an I/O resource to be used for processing relating to an I/O request and an I/O response to the I/O request, and a response standby processing thread. The I/O processing thread: transmits an I/O request to cloud storage in response to a request from a host; and moves the I/O resource to the response standby processing thread if not having received the I/O response from the cloud storage before an elapse of first time-out time. The response standby processing thread transmits a response confirmation to demand the I/O response from the cloud storage by using the I/O resource moved from the I/O processing thread and performs standby processing on the I/O response in place of the I/O processing thread.

### CROSS-REFERENCE TO RELATED APPLICATION

The present application claims priority from Japanese application JP2023-029495, filed on Feb. 28, 2023, the content of which is hereby incorporated by reference into this application.

### TECHNICAL FIELD

The present invention relates to a storage system and an I/O request processing method for the storage system.

### BACKGROUND ART

In recent years, hybrid clouds which use a combination of respective environments of public clouds, private clouds, and on-premises have been becoming widespread. For example, there is a system configured by including: cloud storage which is cloud-based storage constructed on a public cloud(s); and a host(s) constructed on a private cloud(s) or on-premises. In such a system, the cloud storage tends to cause delay in an I/O response to an I/O (Input/Output) request from the host and I/O performance may sometimes degrade due to the occurrence of time-out of the I/O response.

So, as disclosed in PTL 1, when an I/O response from cloud storage in response to an I/O request from a host is in delay, there is a devised technology for deterring the occurrence of time-out by causing the host to reissue I/O before the time-out of the I/O response to the host.

### CITATION LIST

### Patent Literature

PTL 1: U.S. Pat. No. 10,481,805 B1

### SUMMARY OF THE INVENTION

### Problems to be Solved by the Invention

The above-described conventional technology can deter the time-out of the I/O response to the host; however, it has a problem of degradation in the I/O performance because other I/O requests cannot be accepted and the system enters into a standby state while the time-out of the I/O request is deterred.

In consideration of the above-described problems of the conventional technology, it is an object of the present invention to deter the time-out of the I/O response to the I/O request from the host and suppress the degradation in the I/O performance.

### Means to Solve the Problems

In order to solve the above-described problems, there is provided according to an aspect of the present invention a storage system including cloud storage which is cloud-based storage, and a storage node for processing an I/O request to the cloud storage, wherein a processor for the storage node executes an I/O processing thread for retaining an I/O resource including information and a buffer to be used for processing relating to the I/O request and an I/O response transmitted from the cloud storage in response to the I/O request, and a response standby processing thread; wherein the processor causes the I/O processing thread to: transmit the I/O request to the cloud storage in response to a request from a host; [symbol] perform standby processing for waiting to receive the I/O response to the I/O request after transmitting the I/O request to the cloud storage until an elapse of first time-out time; transfer the I/O response to the host if having received the I/O response from the cloud storage before the elapse of the first time-out time; and move the I/O resource to the response standby processing thread and cause the response standby processing thread to retain the I/O resource if not having received the I/O response from the cloud storage before the elapse of the first time-out; and wherein the processor causes the response standby processing thread to transmit a response confirmation for demanding the I/O response from the cloud storage by using the I/O resource moved from the I/O processing thread and retained by the response standby processing thread and perform the standby processing in place of the I/O processing thread.

### Advantageous Effects of the Invention

According to the present invention, it is possible regarding the cloud storage to deter the time-out of the I/O response to the I/O request from the host and suppress the degradation in the I/O performance.

### BRIEF DESCRIPTION OF DRAWINGS

FIG. 1 is a diagram illustrating an example of the configuration of a storage system;

FIG. 2 is a diagram illustrating an example of the configuration of a storage node;

FIG. 3 is a diagram illustrating an example of the configuration of a memory for the storage node;

FIG. 4 is a diagram illustrating an example of a functional configuration of the storage node and the outline of an embodiment;

FIG. 5 is a diagram illustrating an example of the structure of a standby request queue table;

FIG. 6 is a diagram illustrating an example of the structure of a standby resource queue table;

FIG. 7 is a diagram illustrating an example of the structure of an I/O processing thread table;

FIG. 8 is a diagram illustrating an example of the structure of a response standby processing thread table;

FIG. 9 is a diagram illustrating an example of the structure of a cloud storage status management table;

FIG. 10 is a diagram illustrating an example of status transitions of the cloud storage;

FIG. 11 is a diagram illustrating an example of the structure of a rebuild request flag table;

FIG. 12 is a diagram illustrating an example of the structure of a response time-out time table of the cloud storage;

FIG. 13 is a diagram illustrating an example of the structure of a temporary cloud storage blockade count table;

FIG. 14 is a diagram illustrating an example of the structure of an upper-limit temporary cloud storage blockade count table;

FIG. 15A and FIG. 15B are sequence diagrams illustrating an example of I/O request processing; and

FIG. 16 is a flowchart illustrating an example of rebuild processing.

### DESCRIPTION OF EMBODIMENTS

An embodiment according to the disclosure of the present application will be described below with reference to the drawings. The embodiment including the drawings is for illustrative purposes for explaining the present application. In the embodiment, some omissions and simplifications are made as necessary in order to clarify the explanation. Unless particularly limited, each constituent element of the embodiment may be singular or plural. Also, an aspect which is a combination of a certain embodiment and another embodiment may be included in the embodiment according to the disclosure of the present application.

In the description below, the same reference numeral is assigned to the same or similar constituent element; and in an embodiment or example explained later, there may be a case where an explanation about it is omitted or an explanation mainly about any difference(s) will be given. Moreover, if there are a plurality of the same or similar constituent elements, they may be a case where an explanation will be provided by attaching different additional characters to the same reference numeral. Furthermore, if it is unnecessary to distinguish between these plurality of constituent elements, they may sometimes be explained by omitting the additional characters. Unless particularly limited, the number of each configuration elements may be either singular or plural.

In the description below, various types of information will be explained in formats such as tables and queues, but the various types of information may be expressed with data structures other than the tables or the queues. Since an “XX table,” an “XX queue,” etc., do not depend on the data structures, they can be called “XX information.” Expressions such as “identification information,” an “identifier,” a “name,” an “ID,” and a “number” are used when explaining the content of the various types of information, but they are interchangeable.

In the embodiment, an explanation may be sometimes provided about a case where processing is performed by a program. A computer causes a processor (such as a CPU (Central Processing Unit) or a GPU (Graphics Processing Unit)) to execute the program defined by the program by using, for example, a memory for a main storage apparatus. Therefore, a subject of the processing to be performed by executing the program may be the processor. A function unit which performs the processing is implemented by execution of the program by the processor.

Similarly, the subject of the processing to be performed by executing the program may be a controller, apparatus, system, computer, or node having a processor. The subject of the processing to be performed by executing the program may only have to be a computing unit and may include a dedicated circuit for performing specific processing. The dedicated circuit is, for example, an FPGA (Field Programmable Gate Array) or an ASIC (Application Specific Integrated Circuit).

The program may be installed from a program source into a computer. The program source may be, for example, a program distribution server or a computer-readable non-transitory recording medium. If the program source is a program distribution server, the program distribution server may include a processor and storage resources (storage) for storing an object program to be distributed and the processor for the program distribution server may distribute the object program to be distributed to other computers. Furthermore, in the embodiment, two or more programs may be implemented as one program or one program may be implemented as two or more programs.

### Configuration of Storage System S

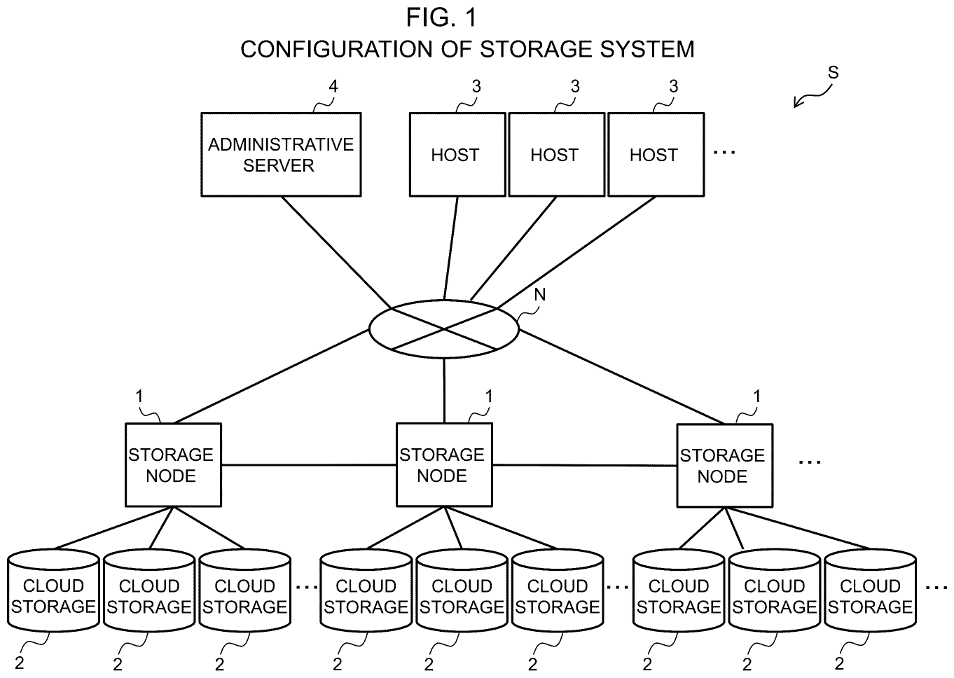

FIG. 1 is a diagram illustrating an example of the configuration of a storage system S. The storage system S is configured by including storage nodes 1, cloud storage 2, hosts 3, and an administrative server 4. The number of each of the storage nodes 1, the cloud storage 2, and the hosts 3 is arbitrary.

The storage node 1 is a virtual server configured from a virtual machine of, for example, a host type, a hypervisor type, or a container type and executes various processes for performing processing relating to I/O and management of data in the cloud storage 2. The storage nodes 1 are connected to each other via an Internode-Subnet.

The cloud storage 2 is cloud-based nonvolatile storage constructed in a cloud environment and is configured by including a virtual volume(s) or a physical disk(s). One or a plurality of units of cloud storage 2 are connected to each storage node 1, thereby configuring each storage cluster.

The host 3 transmits an I/O request to the cloud storage 2 via a network N (Compute-Subnet). The host 3 receives an I/O response to the I/O request from the cloud storage 2 via a network N (Compute-Subnet).

The administrative server 4 is a server for an administrator to perform, for example, maintenance and management of the storage nodes 1 and the cloud storage 2 via the network N (Management-Subnet) or a management network (which is not illustrated in the drawing). The administrative server 4 may be directly connected to the cloud storage 2.

Incidentally, the aforementioned Compute-Subnet, Internode-Subnet, and Management-Subnet may be the same or different from each other. Moreover, the Compute-Subnet, the Internode-Subnet, and the Management-Subnet may be any one of Ethernet (a registered trademark and the same applies hereinafter), InfiniBand (a registered trademark and the same applies hereinafter), and radio networks. Moreover, the networks and communication lines may be redundant.

### Configuration of Storage Node 1

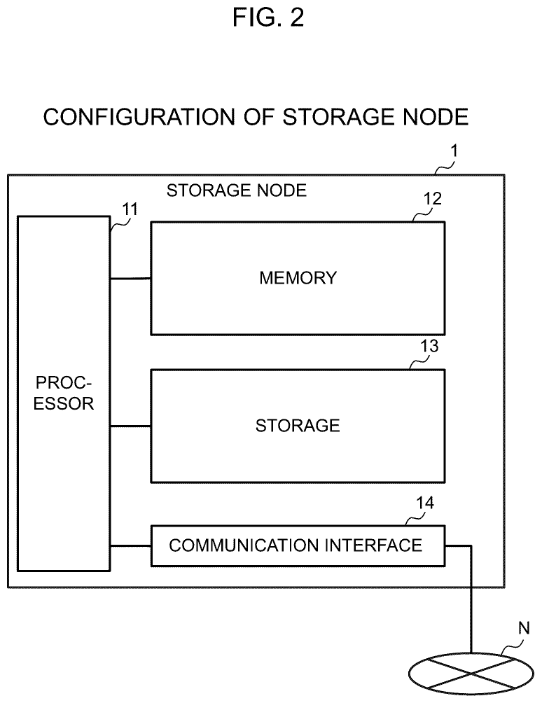

FIG. 2 is a diagram illustrating an example of the configuration of the storage node 1. The storage node 1 is configured by including a processor 11, a memory 12, storage 13, and a communication interface 14. The processor 11 reads a program(s) from the storage 13 and implements each thread and processing function unit described later in cooperation with the memory 12.

The communication interface 14 includes one or more HBAs (Host Bus Adapters) and one or more NICs (Network Interface Cards). The HBA(s) is a communication interface(s) for a data service network (any one of Fiber Channel, Ethernet, InfiniBand, etc.). The NIC(s) is a communication interface(s) for a back-end network (which corresponds to the Compute-Subnet or the Internode-Subnet mentioned earlier and may be any one of Fiber Channel, Ethernet, InfiniBand, etc.).

### Configuration of Memory for Storage Node

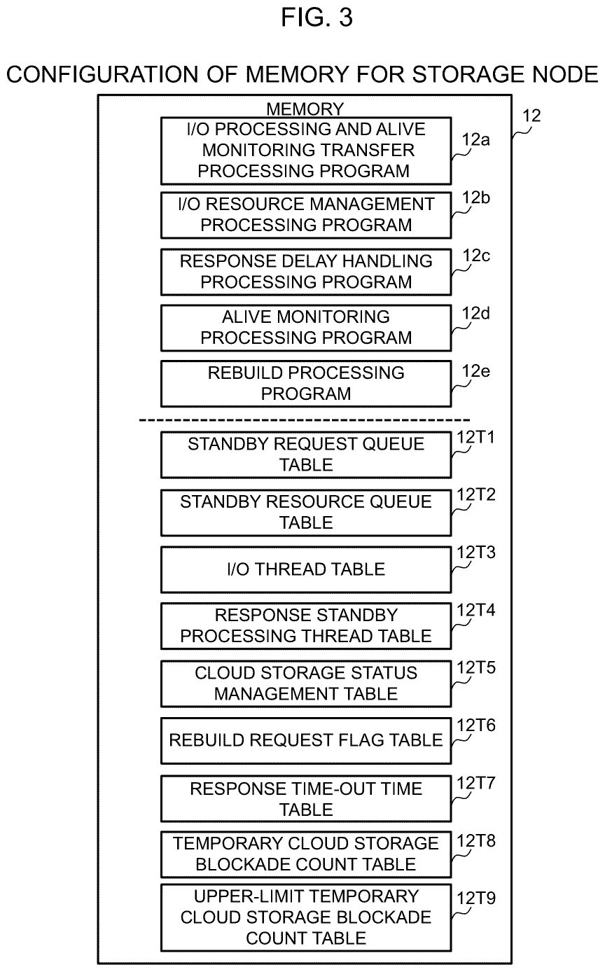

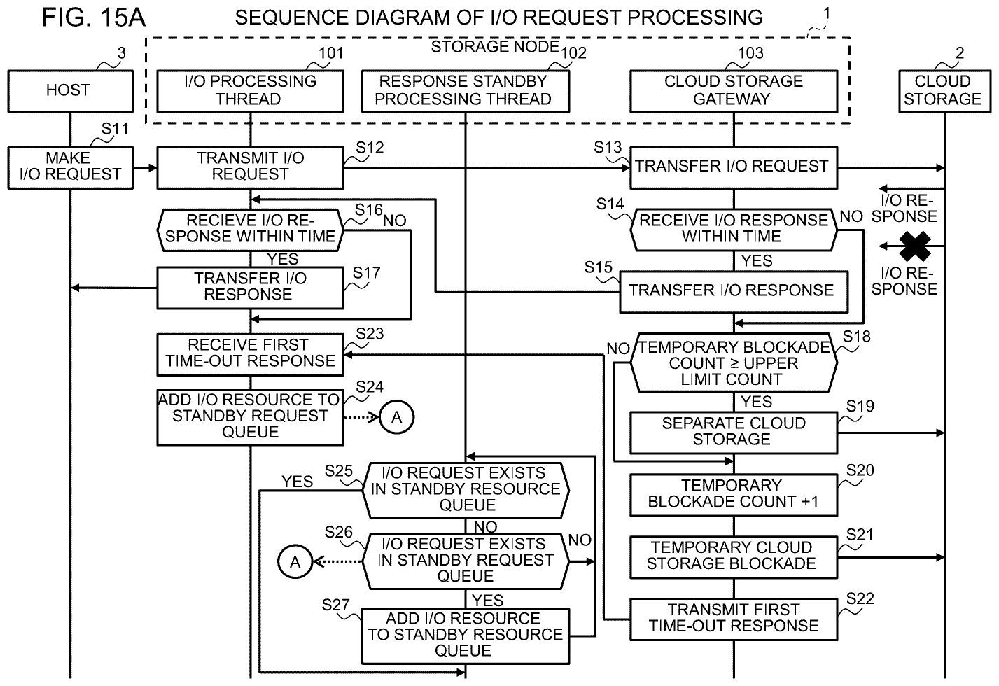

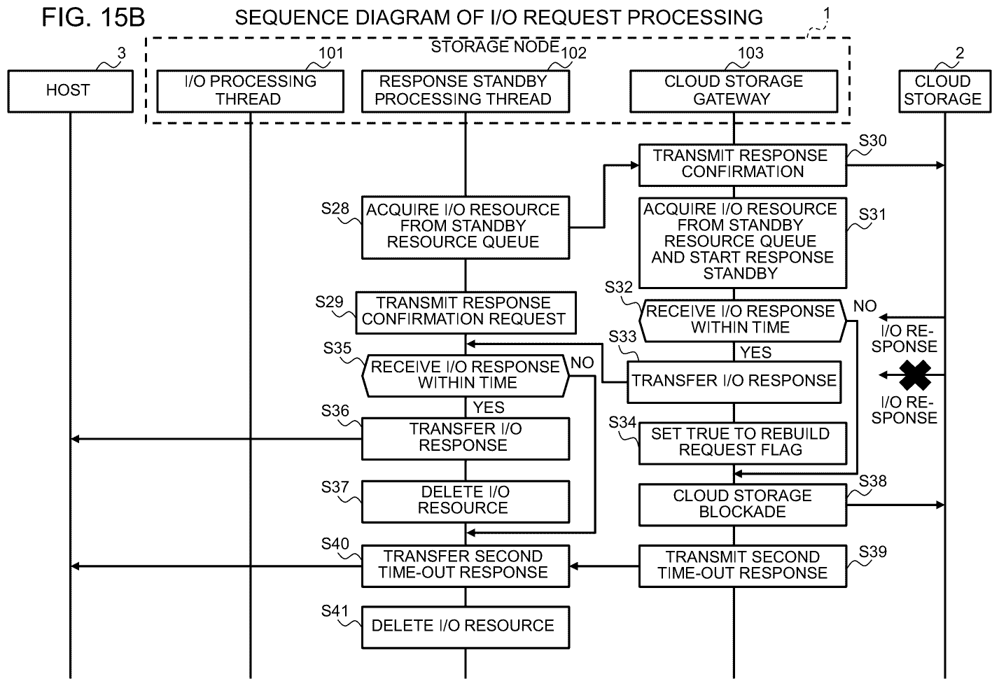

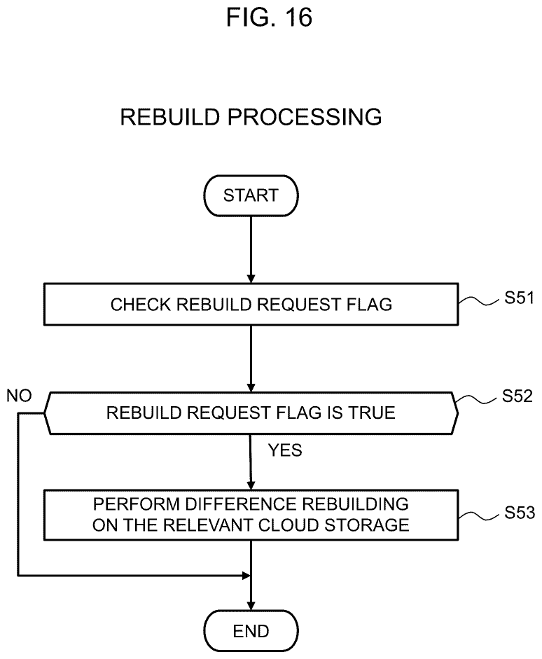

FIG. 3 is a diagram illustrating an example of the configuration of the memory 12 for the storage node 1. An I/O processing and alive monitoring transfer processing program 12a, an I/O resource management processing program 12b, a response delay handling processing program 12c, an alive monitoring processing program 12d, and a rebuild processing program 12e are loaded from the storage 13 and are stored in the memory 12. Processing functions of these programs will be described later with reference to FIG. 15A, FIG. 15B and FIG. 16.

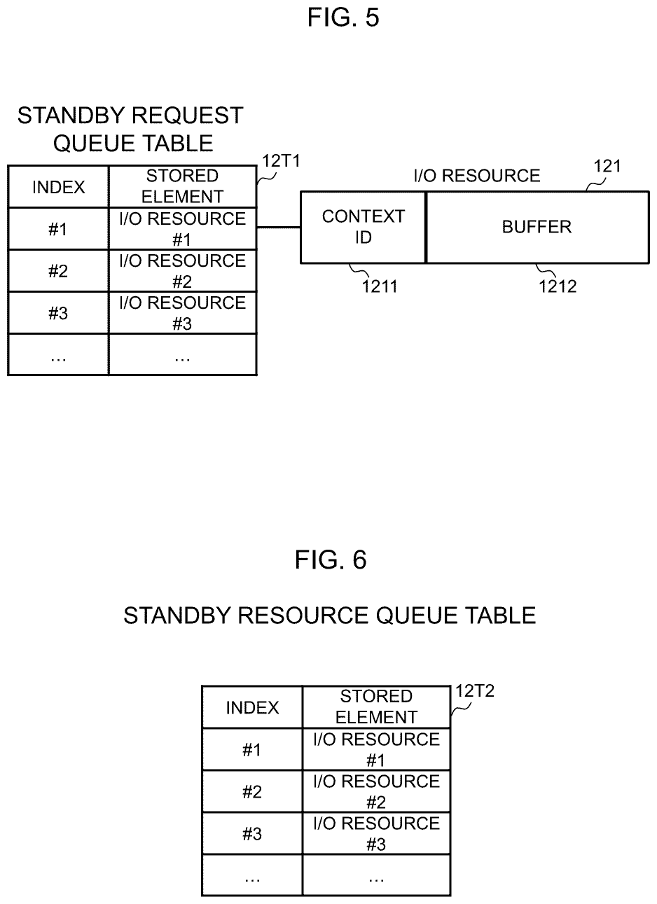

Moreover, the memory 12 stores a standby request queue table 12T1, a standby resource queue table 12T2, an I/O processing thread table 12T3, a response standby processing thread table 12T4, and a cloud storage status management table 12T5. Furthermore, the memory 12 stores a rebuild request flag table 12T6, a response time-out time table 12T7, a temporary cloud storage blockade count table 12T8, and an upper-limit temporary cloud storage blockade count table 12T9. These tables are loaded from the storage 13 and are stored in the memory 12. The details of these tables will be described later with reference to FIG. 5 to FIG. 14.

### Functional Configuration of Storage Node 1 and Outline of Embodiment

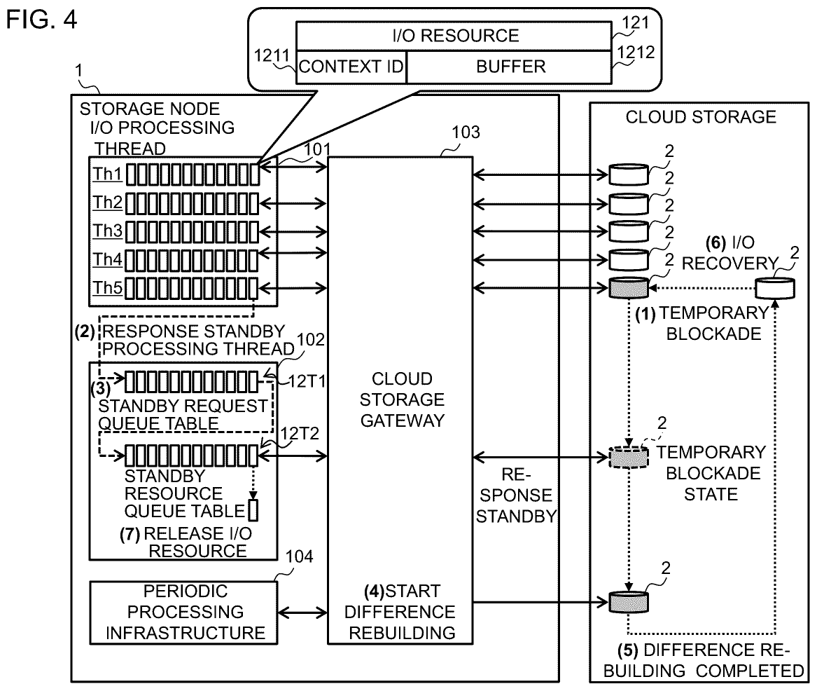

FIG. 4 is a diagram illustrating an example of a functional configuration of the storage node 1 and the outline of an embodiment. The storage node 1 includes an I/O processing thread 101, a response standby processing thread 102, a cloud storage gateway 103, and a periodic processing infrastructure 104.

The I/O processing thread 101 is an instance where the processor 11 executes, in cooperation with the memory 12, the I/O processing and alive monitoring transfer processing program 12a (FIG. 3) loaded from the storage 13 to the memory 12 (FIG. 2).

The I/O processing thread 101 transfers an I/O request from the host 3 to the cloud storage 2 and transfers an I/O response, which is from the cloud storage 2 in response to the I/O request, to the host 3. The I/O processing thread 101 stores an I/O resource(s) 121, which has a context ID 1211 and a buffer 1212, in a queue. The context ID 1211 is identification information of the I/O processing thread 101 that executed I/O processing by using the I/O resource 121 stored in the buffer 1212 and is a migration source from which the I/O resource 121 was migrated to the response standby processing thread 102 described below. The buffer 1212 is a storage area for storing I/O data.

The response standby processing thread 102 is an instance where the processor 11 executes, in cooperation with the memory 12, the I/O resource management processing program 12b (FIG. 3) loaded from the storage 13 to the memory 12 (FIG. 2).

The response standby processing thread 102 has the standby request queue table 12T1 and the standby resource queue table 12T2. The response standby processing thread 102 retains an I/O resource 121, which has been moved from the I/O processing thread 101, in the standby request queue table 12T1. Moreover, the response standby processing thread 102 moves the I/O resource 121 from the standby request queue table 12T1 to the standby resource queue table 12T2 and retains it in the standby resource queue table 12T2, and waits for an I/O response by using the I/O resource 121 retained in the standby resource queue table 12T2.

The cloud storage gateway 103 is an instance where the processor 11 executes, in cooperation with the memory 12, the response delay handling processing program 12c and the alive monitoring processing program 12d (FIG. 3) which are loaded from the storage 13 to the memory 12 (FIG. 2).

The cloud storage gateway 103 cooperates with the I/O processing thread 101, the response standby processing thread 102, and the periodic processing infrastructure 104 to execute various kinds of processing on the cloud storage 2.

The periodic processing infrastructure 104 is an instance where, for example, the rebuild processing program 12e (FIG. 3) loaded from the storage 13 to the memory 12 (FIG. 2) is executed in cooperation with the memory 12.

The periodic processing infrastructure 104 executes rebuild processing (FIG. 16) on the cloud storage 2 to implement data recovery of a RAID (Redundant Array of Independent Disk) in association with the recovery of the cloud storage 2 from the temporary blockade state to the normal state.

The outline of this embodiment will be described below with reference to FIG. 4.

Let us assume that delay in an I/O response from the cloud storage 2 (I/O response delay) has occurred in response to an I/O request transmitted by the I/O processing thread 101. The I/O response delay occurs due to delay in traffic of a cloud network including a communication path for connecting the storage node 1 and the cloud storage 2 and communication paths within the cloud storage 2. There is a case where the I/O response delay may be naturally recovered by, for example, traffic improvement. In order to wait for the natural recovery, the cloud storage 2 which is an object of I/O processing is made to temporarily enter into a temporary blockade state (see (1) in FIG. 4). The temporary blockade state is a state incapable of accepting a new I/O request and capable of accepting only a confirmation of an I/O response (response confirmation) to the existing I/O request regarding which the I/O response delay has occurred.

Next, in order to continue the I/O processing when the I/O response delay of the cloud storage 2 is naturally recovered, an I/O resource 121 (the context ID 1211 and the buffer 1212) required to continue the processing is transferred. Specifically, the I/O resource 121 required to continue the processing is moved to, and retained in, the standby request queue table 12T1 which exists within the response standby processing thread 102 prepared separately from the I/O processing thread 101 (see (2) in FIG. 4).

The standby request queue table 12T1 has a queue structure, corresponding to a plurality of I/O processing threads, and queues the I/O resource(s) 121 transferred from each I/O processing thread 101. One response standby processing thread 102 exists in one storage node 1. A plurality of I/O processing threads 101 exist in one storage node 1 (FIG. 4 shows five I/O processing threads 101 as Th1 to Th5).

While waiting for the natural recovery of the response delay of the cloud storage 2, references are frequently made to the I/O resource 121 corresponding to the I/O response which is being awaited. The standby request queue table 12T1 receives queue push operations from the plurality of I/O processing threads 101, thereby causing inconvenience of high access frequency.

In order to avoid this inconvenience and distribute access loads on the standby request queue table 12T1, the standby resource queue table 12T2 to be referenced when monitoring the delay in the I/O response of the cloud storage 2 is provided separately from the standby request queue table 12T1. The I/O resource 121 which is required to continue the I/O processing is moved from the standby request queue table 12T1 to the standby resource queue table 12T2 and the I/O response from the cloud storage 2 is awaited (see (3) in FIG. 4).

Then, the response standby processing thread 102 receives the I/O response from the cloud storage 2 as a result of the natural recovery of the delay in the I/O response to the I/O request of the cloud storage 2.

Next, the cloud storage gateway 103: starts difference rebuilding, with respect to the cloud storage 2 recovered from the I/O response delay, which is rebuilding targeted at a different part(s) of data as compared to that after the elapse of the first time-out; and implements data recovery of the RAID (see (4) in FIG. 4).

Incidentally, the difference rebuilding is executed on the same cloud storage 2 as the cloud storage 2 which was made to enter into the temporary blockade state in (1) in FIG. 4. This is because if the difference rebuilding is executed on different units of the cloud storage 2, it probably lead to an uneven distribution of the data and the I/O performance will degrade.

Next, when the difference rebuilding of the cloud storage 2 is completed (see (5) in FIG. 4), the cloud storage gateway 103 causes the relevant cloud storage 2 to return to the I/O processing (see (6) in FIG. 4). Also, the response standby processing thread 102 releases the relevant I/O resource 121 from the standby resource queue table 12T2 (see (7) in FIG. 4).

### Structure of Standby Request Queue Table 12T1

FIG. 5 is a diagram illustrating an example of the structure of the standby request queue table 12T1. The standby request queue table 12T1 is a storage container for I/O resources retained by the response standby processing thread 102 and has a queue structure (a data structure of a FIFO format). The I/O resources relating to the cloud storage 2 regarding which the response delay has occurred are added from the plurality of I/O processing threads 101. The number of the I/O resources 121 stored in the standby request queue table 12T1 is arbitrary.

The standby request queue table 12T1 has columns of an “INDEX” and a “Stored Element.” The “INDEX” is identification information of the relevant record. The “Stored Element” stores the I/O resources 121.

### Structure of Standby Resource Queue Table 12T2

FIG. 6 is a diagram illustrating an example of the structure of the standby resource queue table 12T2. The standby resource queue table 12T2 is a storage container for I/O resources retained by the response standby processing thread 102 and has a queue structure. The I/O resources which are stored in the standby request queue table 12T1 are acquired in a sequential order from the top and are added to its queues in a sequential order. The number of the I/O resources 121 stored in the standby resource queue table 12T2 is arbitrary.

The standby resource queue table 12T2 has columns of an “INDEX” and a “Stored Element.” The “INDEX” is identification information of the relevant record. The “Stored Element” stores the I/O resources 121.

### Structure of I/O Processing Thread Table 12T3

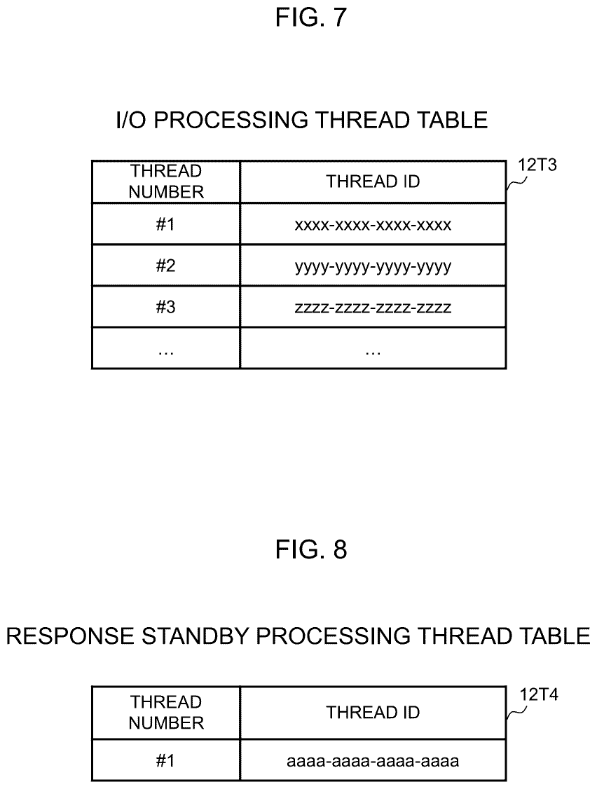

FIG. 7 is a diagram illustrating an example of the structure of the I/O processing thread table 12T3. The I/O processing thread table 12T3 manages an I/O processing thread group for processing I/O requests transmitted from the host 3 and executed by the I/O processing thread 101. One I/O processing thread table 12T3 exists for each one storage node 1. The number of the I/O processing threads 101 is arbitrary according to the operating environment.

The I/O processing thread table 12T3 has columns of a “Thread Number” and a “Thread ID.” The “Thread Number” is identification information of each record of the I/O processing thread table 12T3. The “Thread ID” is identification information of each I/O processing thread 101.

### Structure of Response Standby Processing Thread Table 12T4

FIG. 8 is a diagram illustrating an example of the structure of the response standby processing thread table 12T4. The response standby processing thread table 12T4 manages a response standby processing thread executed by the response standby processing thread 102.

The response standby processing thread table 12T4 has columns of a “Thread Number” and a “Thread ID.” The “Thread Number” is identification information of a record of the response standby processing thread table 12T4. The “Thread ID” is identification information of the response standby processing thread 102.

Incidentally, in this embodiment, there is one response standby processing thread 102 per one storage node 1. So, the response standby processing thread table 12T4 illustrated in FIG. 8 has one record. However, there may be a plurality of response standby processing threads per one storage node 1.

### Structure of Cloud Storage Status Management Table 12T5

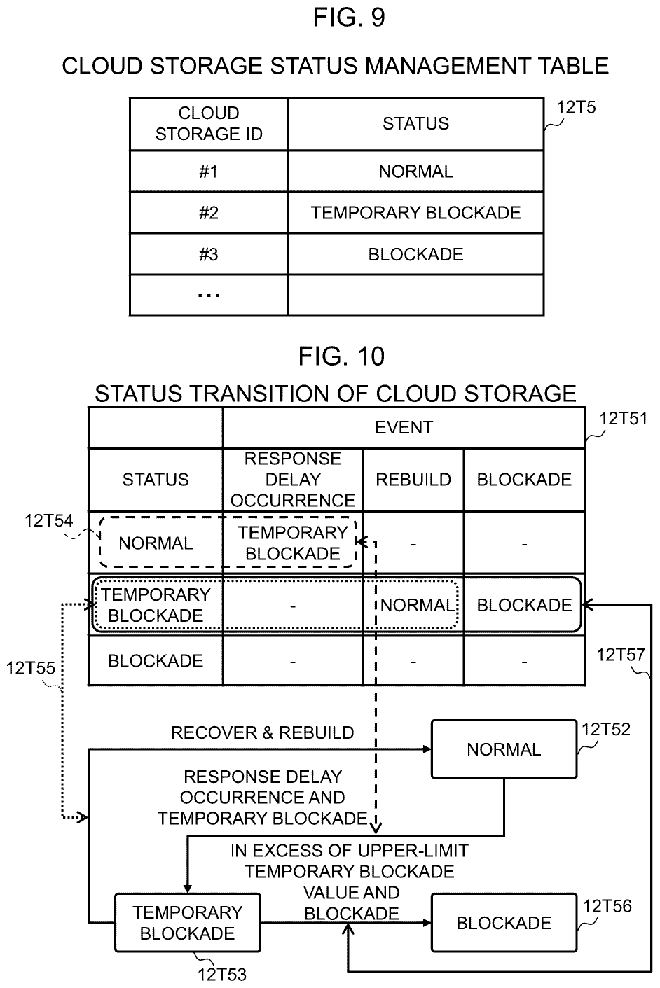

FIG. 9 is a diagram illustrating an example of the structure of the cloud storage status management table 12T5. FIG. 10 is a diagram illustrating an example of the status transition of the cloud storage.

The cloud storage status management table 12T5 has columns of a “Cloud Storage ID” and a “Status.” The “Cloud Storage ID” is identification information of the cloud storage 2. The “Status” is the “status” of the cloud storage 2 corresponding to the “Cloud Storage ID.”

The “Status” of the cloud storage 2 will be explained with reference to FIG. 10. The cloud storage 2 is firstly in a normal state (Status 12T52) as illustrated in FIG. 10 at the timing when the cloud storage 2 is recognized by the storage node 1. The normal state is the state where the cloud storage 2 in a normal state and accepts an I/O request from the host 3.

If the I/O response delay occurs at the cloud storage 2 in the normal state (Status 12T52), the status makes the transition to a temporary blockade state (Status 12T53) (Status Transition 12T54). In the temporary blockade state, the I/O request from the host 3 is not accepted, but a response request from the storage node 1 is accepted. In a case where the I/O response delay of the cloud storage 2 is naturally recovered, it is possible to return to the normal state (Status 12T52) by executing the rebuild processing (Status Transition 12T55).

In the temporary blockade state (Status 12T53), if the I/O response delay is not solved within the time-out time, the cloud storage 2 makes the transition to a blockade state (Status 12T56) (Status Transition 12T57). In the blockade state, the cloud storage 2 does not accept the I/O request from the host 3 or the response request from the storage node 1.

### Structure of Rebuild Request Flag Table 12T6

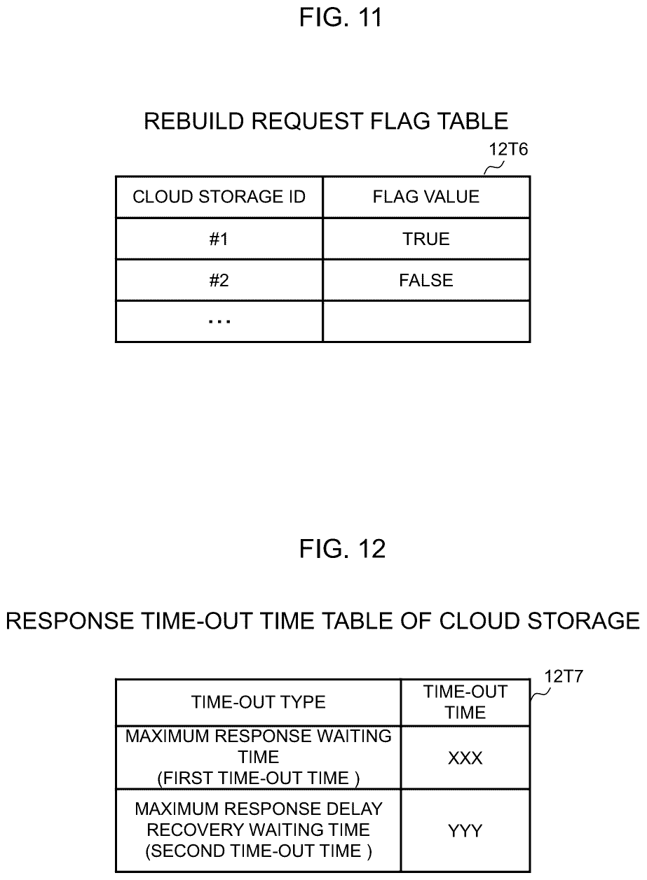

FIG. 11 is a diagram illustrating an example of the structure of the rebuild request flag table 12T6. The rebuild request flag table 12T6 has columns of a “Cloud Storage ID” and a “Flag Value.”

The “Cloud Storage ID” is identification information of the cloud storage 2. The “Flag Value” is a flag value managed for each cloud storage 2; and “true” means that there is a request for the rebuild processing of the relevant cloud storage 2, and “false” means that there is no such request. The periodic processing infrastructure 104 (FIG. 4) monitors the rebuild request flag in arbitrary cycles and executes the rebuild processing on the cloud storage 2 whose rebuild request flag is true.

### Response Time-Out Time Table 12T7 of Cloud Storage

FIG. 12 is a diagram illustrating an example of the structure of the response time-out time table 12T7 of the cloud storage. The response time-out time table 12T7 manages the time-out time regarding responses obtained from the cloud storage 2. One or a plurality of response time-out time tables 12T7 exist for one storage system S.

The response time-out time table 12T7 has columns of a “Time-out Type” and “Time-out Time.” Regarding the “Time-out Type,” there are “Maximum Response Waiting Time (First Time-out Time)” and “Maximum Response Delay Recovery Waiting Time (Second Time-out Time).”

The “Maximum Response Waiting Time” represents maximum waiting time after the I/O processing thread 101 of the storage node 1 issues an I/O request and until the I/O processing thread 101 receives an I/O response transmitted from the cloud storage 2 in response to the I/O request. When the I/O response is not received by the I/O processing thread 101 even after the elapse of the “Maximum Response Waiting Time” since the issuance of the I/O request by the I/O processing thread 101, it is determined that the response delay has occurred at the relevant cloud storage 2. Then, the relevant cloud storage 2 is caused by the cloud storage gateway 103 to make the transition to the temporary blockade state. An arbitrary amount of time is set as the “Maximum Response Waiting Time.”

The “Maximum Response Delay Recovery Waiting Time (Second Time-out Time)” represents the maximum waiting time until the response delay of the cloud storage 2 in the temporary blockade state is naturally recovered. When the delay in the I/O response of the cloud storage 2 is not naturally recovered even after the elapse of the “Maximum Response Delay Recovery Waiting Time” since the transmission of the response confirmation request by the response standby processing thread 102, the I/O response is not received by the response standby processing thread 102. In this case, the relevant cloud storage 2 is made to enter into the blockade state. An arbitrary amount of time is set as the “Maximum Response Delay Recovery Waiting Time (Second Time-out Time).”

Incidentally, the response time-out time table 12T7 may store a uniform value regardless of the individual storage nodes 1 and the individual units of cloud storage 2 or may be a different value for each storage node 1 or each cloud storage 2.

### Structure of Temporary Cloud Storage Blockade Count Table 12T8

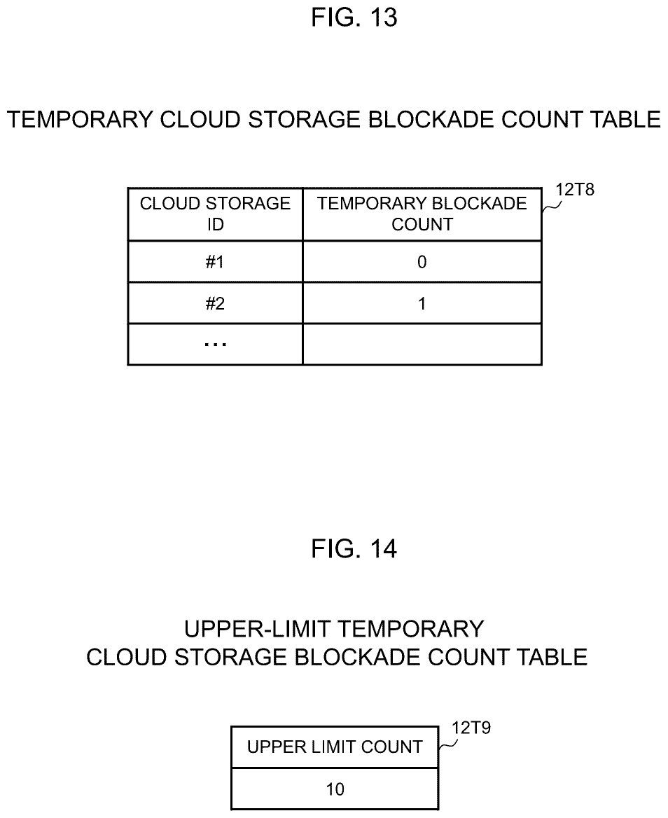

FIG. 13 is a diagram illustrating an example of the structure of the temporary cloud storage blockade count table 12T8. The temporary cloud storage blockade count table 12T8 manages a temporary blockade count of each cloud storage under control with respect to each storage node 1.

The temporary cloud storage blockade count table 12T8 has columns of a “Cloud Storage ID” and a “Temporary Blockade Count.” The “Cloud Storage ID” is identification information of the relevant cloud storage. The “Temporary Blockade Count” is counted up every time the relevant cloud storage 2 causes the occurrence of delay in the I/O response, so it indicates the number of times the delay in the I/O response occurred in the past and the transition to the temporary blockade state was made.

### Upper-Limit Temporary Cloud Storage Blockade Count Table 12T9

FIG. 14 is a diagram illustrating an example of the structure of the upper-limit temporary cloud storage blockade count table 12T9. The upper-limit temporary cloud storage blockade count table 12T9 has columns of a “Cloud Storage ID” and an “Upper Limit Count.”

The “Cloud Storage ID” is identification information of the relevant cloud storage. The “Upper Limit Count” is an upper limit count of the transition of the cloud storage 2 to the temporary blockade state. If the cloud storage 2 causes the delay in the I/O response and when the “Temporary Blockade Count” reaches the “Upper Limit Count,” the relevant storage 2 is detached from the storage system S without making the transition to the temporary blockade state.

### I/O Request Processing According to Embodiment

FIG. 15A and FIG. 15B are sequence diagrams illustrating an example of I/O request processing.

Steps S12, S16, S17, S23, and S24 explained below are processing by the I/O processing and alive monitoring transfer processing program 12a (FIG. 2). Also, steps S25, S26, S27, S28, S29, S35, S36, S37, S40, and S41 are processing by the I/O resource management processing program 12b (FIG. 2). Moreover, step S13, S14, S15, S18, S19, S20, S21, and S22 are processing by the response delay handling processing program 12c (FIG. 2). Furthermore, steps S30, S31, S32, S33, S34, S38, and S39 are processing by the alive monitoring processing program 12d (FIG. 2).

Firstly, in step S11, the host 3 transmits an I/O request to the I/O processing thread 101 (FIG. 4). Next, in step S12, the I/O processing thread 101 transmits an I/O request to the cloud storage 2 in response to the I/O request from the host 3. Then, in step S13, the cloud storage gateway 103 transfers the I/O request, which was received from the I/O processing thread 101, to the cloud storage 2.

In step S14, the cloud storage gateway 103 judges whether or not it has received the I/O response to the I/O request, which was transferred in step S13, from the cloud storage 2 within the maximum response waiting time (FIG. 12). If the cloud storage gateway 103 has received the I/O response within the maximum response waiting time (YES in step S14), it causes the processing to proceed to step S15; and if it fails to receive the I/O response within the maximum response waiting time (NO in step S14), it causes the processing to proceed to step S18.

In step S15, the cloud storage gateway 103 transfers the received I/O response to the I/O processing thread 101.

Then, in step S16, the I/O processing thread 101 judges whether or not it has received an I/O response to the I/O request, which was issued in step S12, within the maximum response waiting time (FIG. 12). If the I/O processing thread 101 has received the I/O response within the maximum response waiting time (YES in step S16), it causes the processing to proceed to step S17; and if it fails to receive the I/O response within the maximum response waiting time (NO in step S16), it causes the processing to proceed to step S23.

Incidentally, step S12 and step S13 may be considered to be performed at the same time. Also, step S14 and step S16 may be considered to be performed at the same time.

In step S17, the I/O processing thread 101 transfers the I/O response, which was received in step S16, to the host 3. When steps S15 and S17 terminate, the I/O request processing terminates.

In step S18, the cloud storage gateway 103 judges whether or not a counter variable value of the temporary blockade count is equal to or larger than (≥) the upper limit count (FIG. 14). When the counter variable value of the temporary blockade count is equal to or larger than (≥) the upper limit count, the cloud storage gateway 103 causes the processing to proceed to step S19; and when the counter variable value of the temporary blockade count is smaller than (<) the upper limit count, it causes the processing to proceed to step S20.

In step S19, the cloud storage gateway 103 detaches the relevant cloud storage 2, which failed to receive the I/O response within the maximum response waiting time in step S14 (FIG. 12), from the storage system S. Specifically, the cloud storage gateway 103 deletes the relevant cloud storage 2 from data I/O and management objects and disconnects it from the storage node 1. Information corresponding to the relevant cloud storage 2 may be deleted from the cloud storage status management table 12T5 (FIG. 9).

Then, in step S20, the cloud storage gateway 103 adds one to the counter variable value of the temporary blockade count. Next, in step S21, the cloud storage gateway 103 causes the status transition of the relevant cloud storage 2, which failed to receive the I/O response within the maximum response waiting time in step S14 (FIG. 12), from the normal state to the temporary blockade state.

Subsequently, in step S22, the cloud storage gateway 103 transmits a first time-out response to the I/O processing thread 101. The first time-out means that the I/O response failed to be received within the maximum response waiting time in step S14 (FIG. 12).

Then, in step S23, the I/O processing thread 101 receives the first time-out response from the cloud storage gateway 103.

Next, in step S24, the I/O processing thread 101 moves an I/O resource 121 (FIG. 4 and FIG. 5) relating to the I/O response from a queue in the I/O processing thread 101 to the response standby processing thread 102. Consequently, the I/O processing thread 101 transfers the standby processing for waiting to receive the I/O response to the response standby processing thread 102.

In step S25, the response standby processing thread 102 judges whether an I/O request with an I/O resource 121 stored in the standby resource queue table 12T2 (FIG. 4 and FIG. 6) within the response standby processing thread 102 exists or not. If the I/O request with the I/O resource 121 stored in the standby resource queue table 12T2 exists (YES in step S25), the response standby processing thread 102 causes the processing to proceed to step S28. On the other hand, if the I/O request with the I/O resource 121 stored in the standby resource queue table 12T2 does not exist (NO in step S25), the response standby processing thread 102 causes the processing to proceed to step S26.

In step S26, the response standby processing thread 102 judges whether an I/O request with the I/O resource 121, which was moved in step S24, stored in the standby request queue table 12T1 (FIG. 4 and FIG. 5) within the response standby processing thread 102 exists or not. If the I/O request with the I/O resource 121 stored in the standby request queue table 12T1 exists (YES in step S26), the response standby processing thread 102 causes the processing to proceed to step S27. On the other, if the I/O request with the I/O resource 121 stored in the standby request queue table 12T1 does not exist (NO in step S26), the response standby processing thread 102 causes the processing to return to step S25.

In step S27, the response standby processing thread 102 fetches the I/O resource 121 at a top position from the standby request queue table 12T1 and adds it to an end position of the standby resource queue table 12T2.

In step S28, the response standby processing thread 102 acquires the I/O resource 121 at a top position of the standby resource queue table 12T2. Then, in step S29, the response standby processing thread 102 transmits a response confirmation request to demand an I/O response, which uses the I/O resource 121 acquired in step S28, from the relevant cloud storage 2.

Then, in step S30, the cloud storage gateway 103 transmits a response confirmation to demand an I/O response from the cloud storage 2 in response to the response confirmation request from the response standby processing thread 102. Next, in step S31, the cloud storage gateway 103 acquires an I/O resource 121 similar to that in step S28 from the standby resource queue table 12T2 and starts I/O response standby processing. The cloud storage gateway 103 repeats steps S30 and S31 at certain intervals until it receives an I/O response relating to the response confirmation or until the maximum response delay recovery waiting time elapses.

Next, in step S32, the cloud storage gateway 103 judges whether or not it has received an I/O response relating to the response confirmation, which was transmitted from the cloud storage 2 in step S30, from the cloud storage 2 within the maximum response delay recovery waiting time (FIG. 12). If the cloud storage gateway 103 has received the I/O response relating to the response confirmation within the maximum response delay recovery waiting time (YES in step S32), it causes the processing to proceed to step S33; and if the cloud storage gateway 103 fails to receive the I/O response relating to the response confirmation within the maximum response delay recovery waiting time (NO in step S32), it causes the processing to proceed to step S38.

In step S33, the cloud storage gateway 103 transfers the I/O response received in step S32 to the response standby processing thread 102. Then, in step S34, the cloud storage gateway 103 sets “true” to the rebuild request flag corresponding to the relevant cloud storage 2 in the rebuild request flag table 12T6 (FIG. 11).

In step S35, the response standby processing thread 102 judges whether or not it has received the I/O response, which was transferred from the cloud storage gateway 103 in step S33, within the maximum response delay recovery waiting time. If the response standby processing thread 102 has received the I/O response within the maximum response delay recovery waiting time (YES in step S35), it causes the processing to proceed to step S36; and if the response standby processing thread 102 fails to receive the I/O response within the maximum response delay recovery waiting time (NO in step S35), it causes the processing to proceed to step S40.

Incidentally, step S29 and step S30 may be considered to be performed at the same time. Also, step S32 and step S35 may be considered to be performed at the same time.

In step S36, the response standby processing thread 102 transfers the I/O response, which was received in step S35, to the host 3. Then, in step S37, the response standby processing thread 102 deletes the I/O resource 121 relating to the processing of the I/O response, which was received in step S35, from the standby resource queue table 12T2 (FIG. 6).

On the other hand, in step S38, the cloud storage gateway 103 causes the status transition of the cloud storage 2, which failed to receive the I/O response within the maximum response delay recovery waiting time (FIG. 12) in step S32, from the temporary blockade state to the blockade state. Next, in step S39, the cloud storage gateway 103 transmits a second time-out response to the response standby processing thread 102. The second time-out means that the I/O response failed to be received within the maximum response delay recovery waiting time (the second time-out time) (FIG. 12) in step S32.

Subsequently, in step S40, the response standby processing thread 102 transfers the second time-out response, which was received from the cloud storage gateway 103, to the host 3. Then, in step S41, the response standby processing thread 102 deletes the I/O resource 121 relating to the second time-out, which was received in step S40, from the standby resource queue table 12T2 (FIG. 6).

### Rebuild Processing According to Embodiment

FIG. 16 is a flowchart illustrating an example of the rebuild processing. The rebuild processing is implemented by periodic execution of the rebuild processing program 12e (FIG. 3) by the periodic processing infrastructure 104 (FIG. 4).

Firstly, in step S51, the periodic processing infrastructure 104 checks the rebuild request flag in the rebuild request flag table 12T6 (FIG. 11). Next in step S52, the periodic processing infrastructure 104 judges, regarding the cloud storage 2 of each cloud storage ID, whether or not it was confirmed in step S51 that the rebuild request flag is set to “true.” The periodic processing infrastructure 104 causes the processing to proceed to step S53 regarding the cloud storage 2 for which it was confirmed in step S51 that the rebuild request flag is set to “true” (YES in step S52). On the other hand, the periodic processing infrastructure 104 terminates this rebuild processing regarding the cloud storage 2 for which it was confirmed that the rebuild request flag is set to “false” (NO in step S52).

In step S53, the periodic processing infrastructure 104 performs difference rebuilding processing on the cloud storage 2 for which the rebuild request flag is set to “true.”

Incidentally, in this rebuild processing, the periodic processing infrastructure 104 performs the difference rebuilding in step S53 as triggered by the recovery of the I/O response from the temporary blockade state of the cloud storage 2 in steps S32 to S34 in the I/O request processing (FIG. 15A and FIG. 15B). Therefore, the cloud storage 2 can recover the redundancy in a much shorter time. The periodic processing infrastructure 104 may perform full rebuilding that is to rebuild all pieces of data included in the cloud storage 2 as triggered by the status transition to the blockade state of the cloud storage 2 in step S38 in the I/O request processing. However, it would take much longer time for the recovery of the redundancy as compared to the difference rebuilding which is triggered by the recovery of the I/O response from the temporary blockade state of the cloud storage 2.

### Advantageous Effects of Embodiment

In the aforementioned embodiment, if not having received the I/O response from the cloud storage 2 before the elapse of the first time-out time in response to the I/O request from the host 3, the I/O processing thread 101 moves the I/O resource 121 to the response standby processing thread 102. Then, the response standby processing thread 102 transmits the response confirmation to demand the I/O response from the cloud storage 2 by using the moved I/O resource 121 and performs the I/O response standby processing in place of the I/O processing thread 101.

Therefore, according to the embodiment, the cloud storage 2 where the delay in the I/O response has occurred is excluded from processing objects of the I/O processing thread 101 and the reception standby for the I/O response is continued by the response standby processing thread 102, so that it is possible to suppress the degradation in the I/O performance relative to the host 3.

Furthermore, according to the aforementioned embodiment, if not having received the I/O response from the cloud storage 2 before the elapse of the first time-out time, the I/O processing thread 101 causes the status transition of the cloud storage 2. Specifically speaking, the I/O processing thread 101 causes the transition from the normal state capable of accepting a new I/O request to the temporary blockade state incapable of accepting the new I/O request and capable of accepting only the response confirmation.

Therefore, according to the embodiment, it is possible to further suppress the degradation in the I/O performance relative to the host 3 by causing the cloud storage 2, where the delay in the I/O response has occurred, to not accept any new I/O request, but focus on the I/O response.

Furthermore, according to the aforementioned embodiment, when the number of times when the status of the cloud storage 2 is changed to the temporary blockade state reaches the upper limit count, the relevant cloud storage 2 is detached from the storage system S.

Therefore, according to the embodiment, it is possible to avoid the delay in the I/O response from frequently occurring by excluding the cloud storage 2, at which the delay in the I/O response frequently occurs, from the storage system S.

Furthermore, according to the aforementioned embodiment, the response standby processing thread 102 transfers the I/O response, which has been received from the cloud storage 2 before the elapse of the second time-out time, to the host 3 and releases the I/O resource 121 relating to the I/O response retained by the response standby processing thread 102.

Therefore, according to the embodiment, the response standby processing thread 102 provides the limitation on the waiting time to receive the I/O response, so that it is possible to prevent the reception standby for the I/O response from staying unlimitedly.

Furthermore, according to the aforementioned embodiment, if having received the I/O response from the cloud storage 2 before the elapse of the second time-out time, the response standby processing thread 102 causes the status transition of the cloud storage 2 from the temporary blockade state to the normal state and executes the difference rebuilding processing.

Therefore, according to the embodiment, when the cloud storage 2 recovers from the delay in the I/O response, it is possible to recover the redundancy early by means of the difference rebuilding.

Furthermore, according to the aforementioned embodiment, if not having received the I/O response from the cloud storage 2 before the elapse of the second time-out time, the response standby processing thread 102 causes the status transition of the cloud storage 2. Specifically speaking, the response standby processing thread 102 causes the transition from the temporary blockade state to the blockade state incapable of accepting the I/O request and the response confirmation. Specifically speaking, the response standby processing thread 102 causes the cloud storage 2, from which the I/O response cannot be received within the limited time, to enter into the blockade state and executes full building.

Therefore, according to the embodiment, it is possible to make the storage system S recover to the normal state earlier than the case where the response standby processing thread 102 continues to wait for the I/O response.

Furthermore, in the aforementioned embodiment, the response standby processing thread 102 has the standby request queue (the standby request queue table 12T1) and the standby resource queue (the standby resource queue table 12T2). Then, the response standby processing thread 102 retains the I/O resource 121, which has been moved from the I/O processing thread 101, in the standby request queue and executes the standby processing relating to the I/O response by using the I/O resource 121 moved from the standby request queue to the standby resource queue.

Therefore, according to the embodiment, upon the response confirmation of, and reception standby for, the I/O response, it is possible to aim at distributing access loads on the queue retaining the I/O resource 121, perform the I/O response reception standby processing without delay, and realize early recovery from the delay in the I/O response from the cloud storage 2.

One embodiment according to the disclosure of the present application has been described above in detail; however, the disclosure of the present application is not limited to the aforementioned embodiment and can be changed in various manners within the scope not departing from the gist thereof. For example, the aforementioned embodiment has been described in detail in order to explain the present invention in an easily comprehensible manner and is not necessarily limited to those having all the configurations explained above. Also, regarding part of the configuration of the aforementioned embodiment, it is possible to add, delete, or replace the configuration of another embodiment.

Furthermore, regarding each aforementioned configuration, function unit, processing unit, processing means, thread, etc., part or whole of them may be implemented by hardware by, for example, designing it with integrated circuits. Moreover, each aforementioned configuration, function, etc., may be implemented by software by a processor by interpreting and executing a program for implementing each function. Information such as programs, tables, and files for implementing each function may be stored in memories, storage devices such as hard disk drives and SSDs (Solid State Drives), or storage media such as IC cards, SD cards, and DVDs.

Furthermore, in each aforementioned drawing, control lines and information lines which are considered to be necessary for the explanation are indicated; however, not all control lines or information lines for implementation may be necessarily indicated. For example, it may be considered that practically almost all the components are connected to each other.

Furthermore, the aforementioned arrangement pattern of the respective functions and data of the storage system S, the storage nodes 1, and the cloud storage 2 is merely one example. The arrangement pattern of the respective functions and data can be changed to an optimum arrangement pattern from the viewpoint of hardware and software performance, processing efficiency, communication efficiency, etc.

### REFERENCE SIGNS LIST

1: storage node(s)
2: cloud storage
3: host(s)
4: administrative server
11: processor
12: memory
12T1: standby request queue table
12T2: standby resource queue table
101: I/O processing thread
102: response standby processing thread
121: I/O resource(s)
S: storage system

1. A storage system comprising cloud storage which is cloud-based storage, and a storage node for processing an I/O request to the cloud storage,
wherein a processor for the storage node executes an I/O processing thread for retaining an I/O resource including information and a buffer to be used for processing relating to the I/O request and an I/O response transmitted from the cloud storage in response to the I/O request, and a response standby processing thread;
wherein the processor causes the I/O processing thread to:
transmit the I/O request to the cloud storage in response to a request from a host;
perform standby processing for waiting to receive the I/O response to the I/O request after transmitting the I/O request to the cloud storage until an elapse of first time-out time;
transfer the I/O response to the host if having received the I/O response from the cloud storage before the elapse of the first time-out time; and
move the I/O resource to the response standby processing thread and cause the response standby processing thread to retain the I/O resource if not having received the I/O response from the cloud storage before the elapse of the first time-out; and
wherein the processor causes the response standby processing thread to transmit a response confirmation for demanding the I/O response from the cloud storage by using the I/O resource moved from the I/O processing thread and retained by the response standby processing thread and perform the standby processing in place of the I/O processing thread.

2. The storage system according to claim 1,
wherein if the I/O response from the cloud storage is not received by the I/O processing thread before the elapse of the first time-out time,
the processor causes a status transition of the cloud storage from a normal state capable of accepting the I/O request which is new, to a temporary blockade state incapable of accepting the new I/O request and capable of accepting only the response confirmation.

3. The storage system according to claim 2,
wherein the processor measures the number of times when the status of the cloud storage is changed to the temporary blockade state; and
when the number of times reaches an upper limit count, the processor detaches the cloud storage from the storage system.

4. The storage system according to claim 2,
wherein the processor causes the response standby processing thread to:
perform the standby processing after transmitting the response confirmation to the cloud storage until an elapse of second time-out time; and
if having received the I/O response from the cloud storage before the elapse of the second time-out time,
transfer the received I/O response to the host and
release the I/O resource relating to the I/O response retained by the response standby processing thread.

5. The storage system according to claim 4,
wherein if the I/O response from the cloud storage is received by the response standby processing thread before the elapse of the second time-out time,
the processor causes the status transition of the cloud storage from the temporary blockade state to the normal state and
executes difference rebuilding processing for recovering data of the cloud storage.

6. The storage system according to claim 4,
wherein if the I/O response from the cloud storage is not received by the response standby processing thread before the elapse of the second time-out time,
the processor causes the status transition of the cloud storage from the temporary blockade state to a blockade state incapable of accepting the I/O request and the response confirmation and
releases the I/O resource relating to the I/O response retained by the response standby processing thread.

7. The storage system according to claim 1,
wherein the response standby processing thread has a standby request queue and a standby resource queue; and
wherein the processor causes the response standby processing thread to:
retain the I/O resource, which has been moved from the I/O processing thread, in the standby request queue; and
move the I/O resource from the standby request queue to the standby resource queue and execute the standby processing relating to the I/O response which uses the I/O resource.

8. An I/O request processing method for a storage system and to be executed by the storage system including cloud storage which is cloud-based storage, and a storage node for processing an I/O request to the cloud storage,
wherein a processor for the storage node executes an I/O processing thread for retaining an I/O resource including information and a buffer to be used for processing relating to the I/O request and an I/O response transmitted from the cloud storage in response to the I/O request, and a response standby processing thread;
wherein the processor causes the I/O processing thread to:
transmit the I/O request to the cloud storage in response to a request from a host;
perform standby processing for waiting to receive the I/O response to the I/O request after transmitting the I/O request to the cloud storage until an elapse of first time-out time;
transfer the I/O response to the host if having received the I/O response from the cloud storage before the elapse of the first time-out time; and
move the I/O resource to the response standby processing thread and cause the response standby processing thread to retain the I/O resource if not having received the I/O response from the cloud storage before the elapse of the first time-out; and
wherein the processor causes the response standby processing thread to transmit a response confirmation for demanding the I/O response from the cloud storage by using the I/O resource moved from the I/O processing thread and retained by the response standby processing thread and perform the standby processing in place of the I/O processing thread.
